(19) United States
(12) Patent Application Publication
(10) Pub. No.: US 2010/0061589 A1
(43) Pub. Date: Mar. 11, 2010

(54) METHOD FOR DETERMINING THE TEMPERATURE OF A DIGITAL X-RAY DETECTOR, METHOD FOR GENERATING A TEMPERATURE-CORRECTED X-RAY IMAGE AND DIGITAL X-RAY DETECTOR

(76) Inventors: Gerhard Hahm, Erlangen (DE); Boris Stowasser, Erlangen (DE)

Correspondence Address: King & Spalding LLP, 401 Congress Avenue, Suite 3200, Austin, TX, 78701, US

(21) Appl. No.: 12/550,569

(22) Filed: Aug. 31, 2009

(30) Foreign Application Priority Data
Sep. 8, 2008 (DE) 10 2008 046 289.6

(51) Int. Cl. G06K 9/00; G01T 1/20; G01K 7/00

(52) U.S. Cl. 382/100; 250/366; 374/163; 374/E07.001

(57) ABSTRACT

In order to improve the image quality of X-ray detectors, a method for determining the temperature of a digital X-ray detector with a scintillator and a pixel matrix of photodiodes is provided at least one point of the X-ray detector. According to the method a reverse voltage is applied to at least a first photodiode, the reverse current of the at least first photodiode is measured, and the temperature of the X-ray detector at the first photodiode is determined from the reverse current.

### CROSS-REFERENCE TO RELATED APPLICATIONS

This application claims priority to DE Patent Application No. 2008 046 289.6 filed Sep. 8, 2008, the contents of which is incorporated herein by reference in its entirety.

### TECHNICAL FIELD

The invention relates to a method for determining the temperature of a digital X-ray detector, a method for generating a temperature-corrected X-ray image, and a digital X-ray detector.

### BACKGROUND

In X-ray imaging, so-called solid state detectors for recording digital X-ray images of an object are known, in which X-rays are converted into light by means of a scintillator and subsequently into electric charge by a pixel matrix of photodiodes in m rows and n columns. Subsequently, the electric charge is read out electronically by means of switching elements, subject to analog/digital conversion and further processed to form a so-called raw X-ray image for generating an image.

The signal of the respective photodiode has to be calibrated on the basis of the individual dose in order to generate a uniform X-ray image. However, this holds true only if the detector is in thermal equilibrium, that is to say if all regions of the pixel matrix are at the same temperature. The X-ray detector is in thermal equilibrium precisely when it is kept at a contrast temperature, for example by an active cooling system. In the case of more recent X-ray detectors, in which an active cooling system has to be dispensed with due to e.g. the weight or which are designed to be mobile, thermal equilibrium is no longer ensured. If there are temperature differences between different regions of the X-ray detector, the temperature has to additionally be taken into account during various image corrections. If this is not effected, artifacts are formed in the X-ray image only due to the thermal differences. In general, temperature variations lead to a reduced image quality in X-ray images.

In order to solve this problem, many X-ray detectors have temperature sensors applied to the substrate at different points of the pixel matrix from below, by means of which sensors the respective temperature is measured. The raw X-ray image is subsequently corrected on the basis of the measured temperatures. However, from a technological point of view, it is almost impossible to apply a sufficient number of such temperature sensors so as to be able to measure all regions of the pixel matrix. The spatial resolution is too low in the case of a justifiable effort.

### SUMMARY

According to various embodiments, a method can be provided which allows comprehensive consideration of the local temperatures with small technological complexity and which is accurate on a pixel level in particular. Furthermore, according to further embodiments, an X-ray detector can be provided suitable for carrying out the method.

According to an embodiment, a method for determining the temperature of a digital X-ray detector comprising a scintillator and a pixel matrix of photodiodes at least one point of the X-ray detector, may comprise the steps of a reverse voltage is applied to at least a first photodiode, the reverse current of the at least first photodiode is measured, the temperature of the X-ray detector at the first photodiode is determined from the reverse current.

According to a further embodiment, the respective photodiode can be screened from radiation and light when the reverse current is measured. According to a further embodiment, respectively one reverse voltage can be applied to a multiplicity of photodiodes of the X-ray detector and the respective temperature is determined from the reverse currents of the photodiodes. According to a further embodiment, the temperature can be determined from the reverse current using the formula

$${I}_{S} ( T ) = {cT}^{3} \cdot exp [ \frac{- {E}_{G}}{kT} ] .$$

According to a further embodiment, the temperature of at least one, in particular all, photodiodes of the X-ray detector can be calibrated before determining the temperature. According to a further embodiment, the X-ray detector may be put into thermal equilibrium for the temperature calibration and the dependence of the reverse current I_{S} on the temperature can be measured for each photodiode.

According to another embodiment, a method for generating a temperature-corrected X-ray image using a digital X-ray detector having a scintillator, a pixel matrix of a multiplicity of photodiodes and actuating and readout electronics, comprising the steps of a raw X-ray image composed of a multiplicity of pixels is recorded and read out, the temperatures of the photodiodes of the pixel matrix used to generate the raw X-ray image are determined using a method for determining the temperature as described above, and wherein the pixels of the raw X-ray image are temperature-corrected on the basis of the determined temperatures of the utilized photodiodes.

According to yet another embodiment, a digital X-ray detector may comprise a scintillator for converting X-rays into light, a pixel matrix of photodiodes for converting the light into electric charge and actuating and readout electronics for actuating the pixel matrix and reading out the electric charge from the X-ray detector, wherein the X-ray detector is assigned an evaluation unit for determining at least one temperature in accordance with a method for determining the temperature as described above.

### BRIEF DESCRIPTION OF THE DRAWINGS

The invention and further advantageous refinements in accordance with the features of the dependent claims are explained in more detail in the following text on the basis of exemplary embodiments which are illustrated schematically in the drawing, without the invention being limited to these exemplary embodiments. In the figures:

FIG. 1 shows a view of a digital X-ray detector based on a solid state detector according to the prior art;

FIG. 2 shows a view of the rear side of an X-ray detector with temperature sensors according to the prior art;

FIG. 3 shows a sequence of steps of a method according to an embodiment for determining the temperature of a digital X-ray detector;

FIG. 4 shows a sequence of steps of a method according to an embodiment for generating a temperature-corrected X-ray image using a digital X-ray detector;

FIG. 5 shows an exemplary curve of the dependence of the reverse current on the temperature.

### DETAILED DESCRIPTION

The various embodiments are based on the recognition that the photodiodes of an X-ray detector itself can be used for measuring the temperature. The method according to an embodiment for determining the temperature of a digital X-ray detector comprising a scintillator and a pixel matrix of photodiodes, wherein a reverse voltage is applied to at least one photodiode, the reverse current of the at least one photodiode is measured, and the temperature of the X-ray detector at the one photodiode is determined from the reverse current provides a very simple, very accurate temperature measurement for the X-ray detector which can be localized to within pixel accuracy. As a result, local temperature-dependent effects can be compensated for by a correction in the raw X-ray image. The corresponding X-ray detector does not require active cooling, as a result of which complicated cooling systems for example can be dispensed with and hence costs can be saved. It is for this reason that the method according to various embodiments can be used in particular for mobile X-ray detectors too.

Advantageously, the respective photodiode is screened from radiation and light when the reverse current is measured. This avoids errors in the temperature measurement which can be caused by incident radiation or light.

In accordance with one embodiment, respectively one reverse voltage is applied to a multiplicity of photodiodes of the X-ray detector and the respective temperature is determined from the reverse currents of the photodiodes. It is even possible for the temperature at every second or even every individual photodiode of the X-ray detector to be measured without much effort.

According to a further embodiment, the temperature is determined from the reverse current using the formula

$${I}_{S} ( T ) = {cT}^{3} \cdot exp [ \frac{- {E}_{G}}{kT} ] ,$$

where c is a constant and E_{G} is the band gap energy of the respectively used material. For example, the band gap energy of silicon is 1.1 eV, and that of germanium is 0.6 eV. According to the Shockley equation, the current through a photodiode is given by the formula

$$I ( U ) = {I}_{S} ( T ) \cdot ( exp [ \frac{eU}{kT} ] - 1 ) ,$$

where e is the elementary charge, k is Boltzmann's constant, T is the temperature and I_{S}(T) is the reverse current. The reverse current has a strong temperature dependence which, as a first approximation for temperatures above 300 Kelvin, can be obtained by the formula shown above.

Advantageously, the temperature of at least one, in particular all, photodiodes of the X-ray detector is calibrated before determining the temperature for a particularly accurate and reliable temperature determination. The temperature calibration serves, inter alia, to determine the constant c. In accordance with a further embodiment, the X-ray detector is put into thermal equilibrium for the temperature calibration and the dependence of the reverse current I_{S} on the temperature is measured for each photodiode. It is subsequently possible to form the inverse function in each case from the resultant curve.

As a result of the method according to an embodiment for generating a temperature-corrected X-ray image, a raw X-ray image composed of a multiplicity of pixels is recorded and read out, the temperatures of the photodiodes of the pixel matrix used to generate the raw X-ray image are determined using a method for determining the temperature as described above, and the pixels of the raw X-ray image are temperature-corrected on the basis of the determined temperatures of the utilized photodiodes using a known method.

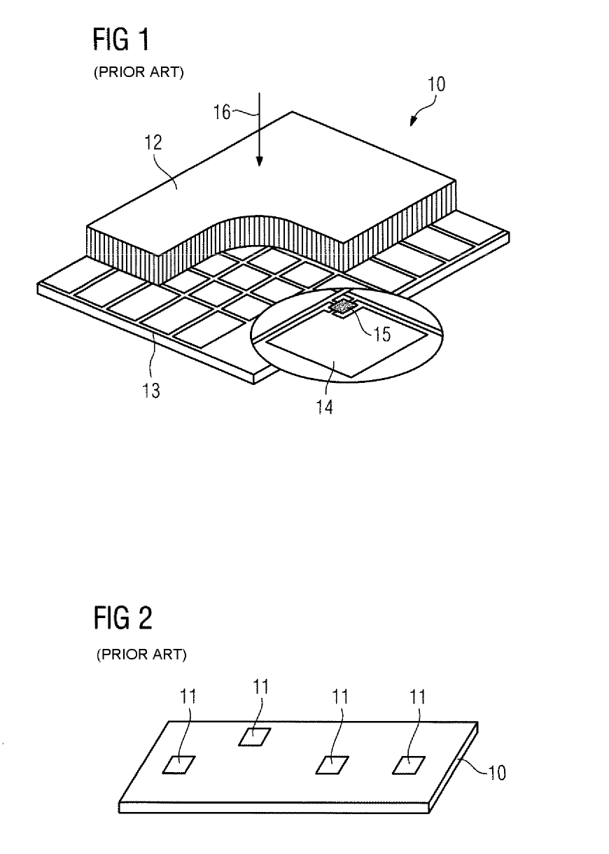

FIG. 1 shows a section of a digital X-ray detector 10, the X-ray detector 10 essentially having a scintillator 12 and an active pixel matrix 13, the scintillator 12 generally being formed by cesium iodide and attached to the active pixel matrix 13. The active pixel matrix 13, which is formed from one or more a-Si plates for example, has a multiplicity of pixels which are arranged in the form of a checkerboard and each contain a photodiode 14. The photodiodes 14 detect light signals which are created by X-rays 16 penetrating the scintillator 12.

Moreover, in addition to the photodiode 14 in which the light is converted into an electrical signal, every pixel contains a switch 15 by means of which the electrical signal is read out. Reading out the multiplicity of pixels arranged in the form of a checkerboard thus generates a raw electronic X-ray image with an image information matrix, which information can be processed in a further process. Due to the specific properties of the X-ray detector 10, it is necessary to post-process the read-out image information to obtain an optimum X-ray image, for example by removing sensitivity differences depending on the individual pixels or differences in the noise from the raw X-ray image.

If the X-ray detector is not in thermal equilibrium, that is to say if the temperature of the X-ray detector has local differences, an additional correction with respect to the temperature differences is necessary. FIG. 2 shows an X-ray detector 10 according to the prior art, with a number of temperature sensors 11 adhesively bonded to the rear side thereof. These temperature sensors 11 are used to determine the temperature of the pixel matrix 13. Many modern X-ray detectors have a very large active surface, e.g. 40×40 cm². Due to the high technical complexity of attaching a multiplicity of temperature sensors 11, in general only a few temperature sensors 11 are used and so it is only possible to generate very approximate temperature profiles of the pixel matrix 13. Accordingly, the prior art does not ensure that the correct temperature is determined for each pixel.

The method according to various embodiments can overcome the problems of the prior art by utilizing the photodiodes for determining the temperature.

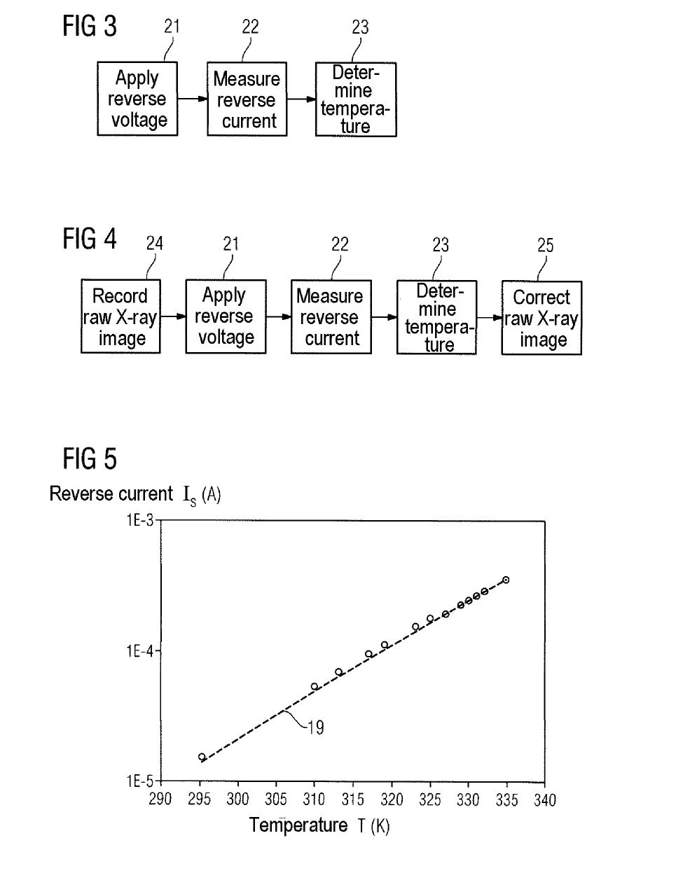

FIG. 3 shows a sequence of the method according to an embodiment for determining the temperature of a digital X-ray detector. In step 21, a reverse voltage is applied to the respective photodiodes 14. This process is controlled, for example, by the system control of the X-ray system which is assigned to the X-ray detector or by a specific control apparatus of the X-ray detector. A reverse voltage can in each case be applied to an arbitrary number of photodiodes, in particular also to all photodiodes of the X-ray detector, depending on which and at how many locations the temperature is intended to be determined. While the reverse voltage is applied, the respective reverse current of the photodiodes is measured in a further step 22. This can in turn be carried out using the system control or the control apparatus.

Subsequently, the respective temperature of the photodiodes used is determined from the measured reverse current in a further step 23. In particular, the formula

$${I}_{s} ( T ) = {cT}^{3} \cdot exp [ \frac{- {E}_{G}}{kT} ]$$

is utilized to this end. The method according to an embodiment can determine the respectively current temperature for all photodiodes. In the case of a pixel matrix of 3000 rows and 3000 columns of pixels, that is to say a total of 9 million photodiodes, this results in a resolution of the order of the pixels.

It is necessary to calibrate the temperature of the X-ray detector before using the X-ray detector in order to know all parameters of the above-stated formula and hence be able to calculate the temperatures particularly accurately. When calibrating the temperature in this way, the detector is successively brought into thermal equilibrium at least two, but preferably at least four, temperatures; to be precise such that all pixels respectively have the same temperature. During the respective thermal equilibrium, that is to say while all pixels have the same temperature, the reverse current is measured for every pixel as a function of the temperature. Using the function I_{S}(i,j)=f(i,j,T) obtained in this way, it is then possible for the respective constant c of the formula disclosed above to be obtained for every pixel in row i and column j. Subsequently, the inverse function of the function is formed: T(i,j)=f⁻¹(i,j,I_{S}(i,j)). This can then be used in each case to determine the temperature during the operation of the X-ray detector. FIG. 5 shows, in an exemplary fashion by means of a curve 19, the dependence of the reverse current I_{S} on the temperature, as is obtained from such a calibration for a fixed pixel.

FIG. 4 shows a sequence of the method according to an embodiment for generating a temperature-corrected X-ray image. To this end, a raw X-ray image is recorded by means of the X-ray detector 10 in a step 24. Subsequently, the respective temperature at an individual photodiode is determined for a multiplicity of photodiodes in steps 21, 22 and 23. Subsequently, the raw X-ray image is corrected on the basis of the temperature information. This can either be effected in the X-ray detector, or in a correction apparatus which is part of an X-ray system to which the X-ray detector is assigned. The temperature-corrected X-ray image then has no more artifacts which can be traced to temperature variations or a lack of thermal equilibrium.

The invention can briefly be summarized as follows: In order to improve the image quality in X-ray detectors, provision is made for a method for determining the temperature of a digital X-ray detector comprising a scintillator and a pixel matrix of photodiodes in a spatially resolved fashion at least one point of the X-ray detector, wherein
a reverse voltage is applied to at least a first photodiode,
the reverse current of the at least first photodiode is measured,
the temperature of the X-ray detector at the first photodiode is determined from the reverse current.

What is claimed is:

1. A method for determining the temperature of a digital X-ray detector comprising a scintillator and a pixel matrix of photodiodes at least one point of the X-ray detector, the method comprising the steps of:
applying a reverse voltage to at least a first photodiode,
measuring the reverse current of the at least first photodiode, and
determining the temperature of the X-ray detector at the first photodiode from the reverse current.

2. The method according to claim 1, wherein the respective photodiode is screened from radiation and light when the reverse current is measured.

3. The method according to claim 1, wherein respectively one reverse voltage is applied to a multiplicity of photodiodes of the X-ray detector and the respective temperature is determined from the reverse currents of the photodiodes.

4. The method according to claim 1, wherein the temperature is determined from the reverse current using the formula
$${I}_{S} ( T ) = {cT}^{3} \cdot exp [ \frac{- {E}_{G}}{kT} ] .$$

5. The method according to claim 1, wherein the temperature of at least one photodiodes of the X-ray detector is calibrated before determining the temperature.

6. The method according to claim 1, wherein the temperature of all photodiodes of the X-ray detector is calibrated before determining the temperature.

7. The method according to claim 1, wherein the X-ray detector is put into thermal equilibrium for the temperature calibration and the dependence of the reverse current I_{S} on the temperature is measured for each photodiode.

8. A method for generating a temperature-corrected X-ray image using a digital X-ray detector having a scintillator, a pixel matrix of a multiplicity of photodiodes and actuating and readout electronics, the method comprising the steps of:
recording and reading out a raw X-ray image composed of a multiplicity of pixels,
determining the temperatures of the photodiodes of the pixel matrix used to generate the raw X-ray image by:
applying a reverse voltage to at least a first photodiode,
measuring the reverse current of the at least first photodiode, and
determining the temperature of the X-ray detector at the first photodiode from the reverse current, and
the pixels of the raw X-ray image are temperature-corrected on the basis of the determined temperatures of the utilized photodiodes.

9. The method according to claim 8, wherein the respective photodiode is screened from radiation and light when the reverse current is measured.

10. The method according to claim 8, wherein respectively one reverse voltage is applied to a multiplicity of photodiodes of the X-ray detector and the respective temperature is determined from the reverse currents of the photodiodes.

11. The method according to claim 8, wherein the temperature is determined from the reverse current using the formula
$${I}_{S} ( T ) = {cT}^{3} \cdot exp [ \frac{- {E}_{G}}{kT} ] .$$

12. The method according to claim 8, wherein the temperature of at least one photodiodes of the X-ray detector is calibrated before determining the temperature.

13. The method according to claim 8, wherein the temperature of all photodiodes of the X-ray detector is calibrated before determining the temperature.

14. The method according to claim 8, wherein the X-ray detector is put into thermal equilibrium for the temperature calibration and the dependence of the reverse current I_{S} on the temperature is measured for each photodiode.

15. A digital X-ray detector comprising a scintillator for converting X-rays into light, a pixel matrix of photodiodes for converting the light into electric charge and actuating and readout electronics for actuating the pixel matrix and reading out the electric charge from the X-ray detector, wherein the X-ray detector is assigned an evaluation unit for determining at least one temperature, wherein the evaluation unit is operable to:
apply a reverse voltage to at least a first photodiode,
measure the reverse current of the at least first photodiode, and
determine the temperature of the X-ray detector at the first photodiode from the reverse current.

16. The digital X-ray detector according to claim 15, wherein the respective photodiode is screened from radiation and light when the reverse current is measured.

17. The digital X-ray detector according to claim 15, wherein respectively one reverse voltage is applied to a multiplicity of photodiodes of the X-ray detector and the respective temperature is determined from the reverse currents of the photodiodes.

18. The digital X-ray detector according to claim 15, wherein the temperature is determined from the reverse current using the formula
$${I}_{S} ( T ) = {cT}^{3} \cdot exp [ \frac{- {E}_{G}}{kT} ] .$$

19. The digital X-ray detector according to claim 15, wherein the temperature of at least one or all photodiodes of the X-ray detector is calibrated before determining the temperature.

20. The digital X-ray detector according to claim 15, wherein the X-ray detector is put into thermal equilibrium for the temperature calibration and the dependence of the reverse current I_{S} on the temperature is measured for each photodiode.
